(19) United States
(12) Patent Application Publication
(10) Pub. No.: US 2023/0152190 A1
(43) Pub. Date: May 18, 2023

(54) KIT WITH SEPARATING DEVICE AND PARTICLE SENSOR, USE OF THE KIT, DUST DEVICE AND METHOD FOR CONTROLLING THE DUST DEVICE

(71) Applicant: Hilti Aktiengesellschaft, Schaan (LI)

(72) Inventor: Oliver OHLENDORF, Landsberg (DE)

(21) Appl. No.: 17/917,314

(22) PCT Filed: Apr. 13, 2021
(86) PCT No.: PCT/EP2021/059523

§ 371 Date: Oct. 6, 2022

(30) Foreign Application Priority Data
Apr. 22, 2020 (WO) 20170760.1

(51) Int. Cl. G01N 1/22

(52) U.S. Cl. CPC G01N 1/2202; G01N 1/2273; G01N 2015/0019

(57) ABSTRACT

A kit has a separating device and a particle sensor. The separating device is arranged upstream of the particle sensor and is set up to leave only respirable particles in the fluid stream, so that only those particles which have a particle diameter in a range from 0 to 10 μm reach the particle sensor and are analyzed by it. As a result, the particle sensor can be effectively protected from undesired contamination and its measuring accuracy can be increased considerably by reducing the number of particles to be analyzed that enter its measuring region. In a second aspect, the invention relates to the use of the proposed kit in a dust device. In further aspects, the invention relates to a dust device which includes a proposed kit, as well as a method for controlling a dust device in dependence on the measurement data determined with the kit.

The present invention relates to a kit which comprises a separating device and a particle sensor, to a dust device with the kit and to the use of the kit in a dust device.

### BACKGROUND

Particle or dust sensors which are used to determine the air quality in a room or an air volume are known in the prior art. Conventional dust sensors, as they are known from the prior art, work with a constant measuring air volume flow. In other words, the entire suspended dust fraction is sucked in and examined in the measuring devices. This two-phase flow can be analyzed in the known measuring devices. Suspended particles have for example a diameter of 0 to well over 100 μm.

### SUMMARY OF THE INVENTION

The disadvantage of the known measuring devices is that most devices are not designed for the analysis of dust particles in the entire diameter range that occurs. Most of the conventional devices have an optimum operating range, which can be set for example by calibrating the device. In the prior art, measuring devices which are designed to analyze particles with a diameter of 0 to 16 μm are known for example. The calibration of these devices can be specified for example by the so-called PM value. The problem thus arises that, although the measuring device is only designed to analyze a small range of particle diameters, a fluid stream with particles of all particle sizes is sent through the conventional measuring devices. The excess particles, which actually do not contribute to the analysis because their diameters are not in the calibration range of the measuring device, are not simply passed through the measuring device. Rather, they reduce the measuring accuracy of the measuring device and can lead to undesired contamination and resultant damage of the dust sensor.

An object of the present invention is provide a measuring device with which the examination of a fluid stream to be analyzed can be improved. In particular, the measuring accuracy of the measurements that are carried out with the measuring device is to be increased and the risk of contamination within the measuring device is to be reduced. In addition, a dust device with an improved possibility of analyzing a fluid stream can be provided, as well as a control method for this dust device.

The present invention provides a separating device and a particle sensor, the particle sensor being set up to analyze particles in a fluid stream. The kit is characterized in that the separating device in the kit is arranged upstream of the particle sensor and is set up to leave only respirable particles in the fluid stream, so that only the respirable particles reach the particle sensor and are analyzed by it.

In particular, the invention relates to a specific arrangement of a separating device with certain properties in relation to a particle sensor. The arrangement is characterized in that the separating device is arranged within the kit at a first position, while the particle sensor is arranged downstream of the separating device at a second position within the kit. In other words, the separating device is arranged upstream of the particle sensor in the direction of flow or the fluid stream to be analyzed first passes the separating device and then the particle sensor. It is preferred in the context of the invention that a measuring path begins downstream of the separating device and includes a measuring region of the particle sensor. The examination of the particles in the fluid stream by the kit preferably takes place in the measuring region of the particle sensor. The proposed arrangement or sequence of the components of the proposed kit advantageously means that a considerable part of the particles can be filtered out of the fluid stream with the separating device, so that this filtered-out fraction no longer reaches the particle sensor. It has been found that the evaluation or analysis of a measurement fluid volume works all the better, the fewer particles there are in total in the measurement fluid volume. Since, with the proposed invention or the specific arrangement of the components in the proposed kit, a considerable proportion of particles can be filtered out or deposited from the measurement fluid volume before the fluid stream reaches the particle sensor, the total amount of particles to be analyzed by the particle sensor is significantly reduced. In particular, with the invention, those particles which are not absolutely necessary for the analysis of the fluid stream with regard to its health relevance can be filtered out of the fluid stream. In other words, in particular excess particles are filtered out by the separating device and in particular the health-relevant particles in the fluid stream are examined by the particle sensor. In this way, on the one hand the measuring accuracy of the particle sensor can be significantly improved. On the other hand, the particle sensor can be effectively protected from contamination. This protection from contamination relates in particular to the sensitive, preferably optically operating detection unit of the particle sensor.

The fluid stream to be analyzed is in particular an aerosol stream. In the context of the invention, this preferably means that the fluid or aerosol stream is formed by a heterogeneous mixture which comprises solid suspended particles and a fluid, preferably a gas or a gas mixture. The suspended particles may be in particular dust particles of various sizes. The fluid is preferably the known oxygen-nitrogen mixture that forms the earth's atmosphere. The dust particles have diameters in a range from 1 to more than 100 μm. Dust particles that have a diameter of 0 to 10 μm are referred to in the context of the invention as respirable particles. The alveoli form the human lungs as air sacs, and the gas exchange in the human body takes place in the alveoli. There, oxygen from the lungs is released into the blood and, conversely, carbon dioxide is absorbed from the blood into the lungs in order to remove the carbon dioxide from the human body through exhalation. Tests have shown that especially particles with a diameter of 0 to 10 μm can overcome the physical barrier that is formed by the walls of the alveoli, which is why such particles are classified as particularly hazardous to health. Dust with particle diameters of 0 to 10 μm is preferably referred to in the context of the invention as fine dust.

Furthermore, the fluid or aerosol stream comprises particles which have larger particle diameters. For example, thoracic particles have a diameter of up to 30 μm, while the so-called “inhalable” particles have particle diameters of 10 μm to for example 1000 μm, preferably up to 500 μm and particularly preferably up to 100 μm. Tests have shown that it is primarily the particles with a particle diameter of greater than 10 μm that are responsible for contamination of conventional particle sensors. The contamination can lead to detection difficulties, increased measurement inaccuracies, damage or a possible total failure of the particle sensor. It is therefore an essential advantage that is achieved with the present invention that particles with a particle diameter of greater than 10 μm can be filtered out of the measurement fluid stream in order that these particles do not come into contact with the particle sensor in the first place. In other words, it is preferred in the context of the invention that particles with a diameter of greater than 10 μm can be filtered out of the fluid stream by the separating device and removed from the fluid stream, so that these particles are effectively prevented from reaching the particle sensor. To remove the larger particles, it is proposed in particular to arrange a separating device upstream of the particle sensor within the proposed kit. The separating device is set up to remove particles with a particle diameter of greater than 10 μm from the aerosol stream in a particularly safe and reliable manner. This advantageously achieves the effect that only the respirable fine dust particles that are particularly relevant for the measurement and analysis enter the measuring region of the particle sensor. In other words, with the invention it can be ensured that only the health-relevant fraction of particles arrives at the particle sensor and can be analyzed. In addition, the particle sensor is reliably protected from undesired contamination and damage resulting therefrom. As a result, an improved measuring accuracy of the particle sensor can be achieved and the service life of the sensor can be increased considerably. Advantageously, with the invention, in particular the total number of particles to be analyzed is reduced, as a result of which the measuring accuracy of the particle sensor can be increased. It is particularly preferred in the context of the invention that the particles to be analyzed are analyzed by the particle sensor, in particular with regard to their size, i.e. their diameter.

Another essential advantage that is achieved with the invention is that the fraction of health-relevant particles is essentially not influenced by the filtering out of the non-respirable particles, since these particles just remain in the fluid stream and are analyzed by the particle sensor. In this respect, despite the reduction in the number of particles, which significantly increases the measuring accuracy of the kit, there is no influencing or distortion of the measurement results. Tests have shown that surprisingly accurate measurement results can be obtained with the proposed arrangement of the separating device and the particle sensor in relation to one another.

It is preferred in the context of the invention that the separating device is designed as a centrifugal separator, deflection chamber or as a cyclone. In a centrifugal separator or a cyclone, the centrifugal force is used to filter the solid particles out of the aerosol or fluid stream. Separating devices, such as centrifugal separators or cyclones, are preferably based on the principle of mass force separation, the different masses of different types of particles being used in particular to sort the particles by weight and, if the density is similar, also by size or diameter. To separate the differently sized particles, a vortex flow may be generated in the separating device, the differently sized particles being exposed to centrifugal forces of different magnitudes due to their differently sized masses. Tests have shown that, in the context of the present invention, centrifugal separators or cyclones, which are used as the separating device in the proposed kit, are particularly well suited to filtering particles with a diameter of greater than 10 μm out of the fluid stream.

In the context of the invention, a deflection chamber may preferably be a chamber in which a fluid stream is deflected as strongly as possible over a short distance. In other words, the deflection chamber is preferably designed in its interior such that a fluid stream can experience a particularly strong deflection.

It is preferred in the context of the invention that the separating device is a selectively operating separating device. In the context of the invention, this preferably means that the separating device is set up to filter particles out of the fluid stream depending on the particle diameter. For example, it is most particularly preferred in the context of the invention that the separating device is set up to filter particles with a diameter of greater than 10 μm out of the fluid stream, while particles with a smaller particle diameter, i.e. a particle diameter of less than 10 μm or in a range from 0 to 10 μm, remain in the aerosol stream. In other words, the separating device can function as a filter, the separating device being set up in particular to select the particles to be analyzed according to particle diameter and selectively let them through or filter them out. The term “let through” preferably means in the context of the invention that the particles “let through” can remain in the fluid stream, so that they can be analyzed by the particle sensor at a position downstream of the separating device within the proposed kit. It is most particularly preferred in the context of the invention that the preferably selectively operating separating device is set up to allow respirable particles to pass through, while it is also set up to filter thoracic and inhalable particles out of the aerosol stream.

The use of a selectively operating separating device is especially advantageous when the particle sensor is a particle sensor which is calibrated in particular to small particle sizes. Since such particle sensors that are calibrated to small particle sizes ensure a resolution and measuring accuracy that is in any case better than uncalibrated sensors, the provision of the preferably selectively operating separating device further improves the measuring accuracy of the particle sensor, so that particularly accurate and meaningful measurement results are obtained.

It is preferred in the context of the invention that the particle sensor is an optically operating particle sensor. The particle sensor of the proposed kit may for example be based on the principle of laser scattering, with the measurement data optically collected in this way being able to be evaluated and analyzed using various evaluation methods and algorithms.

In a second aspect, the invention relates to the use of the proposed kit in a dust device. The kit may be used in particular for the detection or analysis of particles in a fluid stream flowing through the dust device. In a particularly preferred embodiment, the use of the kit is characterized in that the separating device is arranged upstream of the particle sensor within the kit and is set up to leave only respirable particles in the fluid stream, so that only the respirable particles reach the particle sensor and are analyzed by it. The respirable particles preferably have particle diameters in a range from 0 to 10 μm. Thus, the separating device is preferably set up to filter particles with a diameter of greater than 10 μm out of the fluid stream, so that these particles with a diameter of greater than 10 μm have to leave the fluid stream before they reach the particle sensor or its measuring region.

In a particularly preferred embodiment of the invention, the proposed kit can be used for controlling the dust device. The control of the dust device takes place in particular in dependence on measurement data that are collected with the kit. It is preferred that the measurement data that are used for controlling the dust device are collected with the kit, preferably the particle sensor of the kit. The separating device of the kit is in this case arranged upstream of the particle sensor. In the context of the invention, this preferably means that the separating device is present in a first position within the kit and the particle sensor is present in a second position within the kit. It is preferred in the context of the invention that particles which are to be examined or analyzed in dependence on their diameter first enter the separating device. There the particles are preferably sorted and filtered in such a way that only respirable particles remain in the fluid stream, while particles with a diameter of greater than 10 μm are filtered out by the separating device and have to leave the fluid stream. This means that advantageously only a fraction of the particles previously contained in the fluid stream remain in the fluid stream which is subsequently analyzed by the particle sensor. This increases the measuring accuracy of the sensor and protects the preferably optical detection unit of the particle sensor from contamination and damage resulting therefrom. The measurement data that can be collected with the kit and used to control the dust device relate in particular to the particle sizes of the particles in the fluid stream to be analyzed.

It is preferred in the context of the invention that the particle sensor is set up for example to detect a number of particles and a volume flow. The particle concentration can advantageously be calculated from these measured values. The particle concentration may for example be given in the unit milligrams per cubic meter (mg/m³). In particular, the determined particle concentration may be assigned to a particle size range in accordance with the PM categorization. It is most particularly preferred in the context of the invention that the particle concentration can be used as a dust concentration value in order to control a dust device. In this context, it may be preferred to use the particle concentration as a controlled variable in a closed-loop and open-loop control circuit. In other words, it may be most particularly preferred in the context of the invention to control the dust device in dependence on the particle concentration or the dust concentration value as a controlled variable.

It is preferred in the context of the invention that the dust device is an air cleaner, a vacuuming device or a dust detection device. The air cleaner may be for example a stand-alone device for cleaning air in a preferably essentially closed space. Such air cleaners are used for example on construction sites to bind dust or to remove dust from the work area of a worker. However, air cleaners can also be used in many other areas, for example in clean room monitoring, in clinics and care facilities or in public buildings for monitoring air quality.

It is known that, for example when working with power tools, dust, in particular fine dust, can arise. The power tools that are used on construction sites are preferably grinding or polishing machines, saws, drilling or chiselling devices, as well as core drilling devices, without being restricted thereto. Particularly when working inside buildings, i.e. when carrying out renovating or repair work, problems can arise with the removal of dust, since for example there is no wind in closed rooms. Air cleaners are used successfully here to reduce the dust pollution for the workers working on the construction site and the users of the power tools. Since not all dust is equally harmful to human health, there is an interest in finding out how the dust is actually composed and to what extent it is a health hazard for those working on the construction site. This interest can be satisfied by the invention in that the proposed kit makes a contribution to the extent that dust can be analyzed with an increased measuring accuracy. Furthermore, with the invention, in particular that fraction in the dust which is particularly relevant to health can be examined. The use of the invention in a construction site context has proven to be particularly advantageous due to the generally particularly high dust exposure of the workers. Due to the particularly dense dust-laden air, the invention can make a significant contribution to the extent that, despite the high dust load in the air, particularly accurate and reliable measurement results can be obtained from the particle sensor, in that in particular the larger and actually less relevant particles for the measurement do not enter the measuring region of the sensor in the first place.

This advantage of the invention is achieved in particular by the arrangement of the separating device and particle sensor within the proposed kit. It is provided according to the invention that a fluid stream to be analyzed with particles to be analyzed first enters the separating device of the kit. There the particles are filtered or selected according to their size or their diameter. It is also provided that the separating device only allows particles which have a diameter in a range from 0 to 10 μm to pass. Larger particles are filtered out by the separating device and removed from the fluid stream. In particular, the particles remaining in the fluid stream with a diameter in a range from 0 to 10 μm are passed on to the particle sensor. There, i.e. downstream of the separating device, an analysis of the particles can take place, the measurement data collected with the particle sensor, for example relating to the composition of the particles in the fluid stream or their size distribution, advantageously being able to be used to control a dust device interacting with the kit, i.e. for example to switch it on or off. By filtering out particles that are not respirable, i.e. do not constitute fine dust because they have a diameter of greater than 10 μm, particularly fine and finely calibrated particle sensors, which previously could scarcely be used in the construction industry because they got dirty too quickly and became unusable, can also be used on construction sites.

It is particularly preferred in the context of the invention that the measured values obtained with the particle sensor can be used to control a dust device. For example, the dust device, for example the air cleaner or a vacuum cleaner, can be switched on or off in dependence on the measured values that are determined with the particle sensor. If, for example, the particle sensor detects a particularly high number of health-relevant fine dust particles in the air of a room or area of a construction site to be monitored, the dust device can be switched on. In the event of a significant reduction in the health-relevant fine dust particles in the air that can be detected by the particle sensor, the dust device can advantageously be switched off again. For this purpose, the proposed kit, in particular the particle sensor, may be connected to the dust device in terms of information technology via a communication link. It is most particularly preferred in the context of the invention that the dust device comprises a control unit to which the kit or the particle sensor is connected via the communication link. The communication link may for example be based on WLAN or Bluetooth. Control commands based on the measurement results determined with the kit may preferably be transmitted from the kit, in particular the particle sensor, to the dust device, the control commands in the dust device being able to lead to a change in state, change in the operating state or change in operating parameters. In other words, the measurement data determined by the particle sensor can be used not only for switching the dust device on or off, but also to set or regulate operating parameters of the dust device, preferably also steplessly. The control commands are preferably implemented in the control unit of the dust device, the control unit preferably being set up to interact with components of the dust device and to control and/or actuate them. The components of the dust device may be for example motors, turbines, pumps or the like that perform essential functions of the respective dust device. It may also be preferred in the context of the invention that the measured values of the particle sensor are only evaluated in the control unit of the dust device. In this case, in particular, the preferably raw measurement results are transmitted from the kit to the dust device using the communication link.

The dust device may also be a vacuuming device, such as a vacuum cleaner or a construction-site vacuum cleaner. The vacuuming device may for example comprise a proposed kit or be controlled by the kit. This control in dependence on measured values that are collected with the kit, preferably the particle sensor of the kit, takes place in a manner analogous to the control as described above with respect to the air cleaner.

The proposed kit may also be used in connection with a dust detection device. For example, it is conceivable to equip the workers on a construction site with a personal dust detection device in the sense of an individual “dust dosimeter”, which is able to determine or display or evaluate the individual dust exposure of a worker, for example per unit of time. By using the proposed kit in such a personal dust detection device, the fine dust exposure of the individual worker can be determined particularly accurately. The personal dust detection device may have suitable communication means to forward the determined dust exposure data or the fine dust quantities to a central processing or storage device, so that for example an employer or construction site operator can if necessary take suitable countermeasures to reduce the dust exposure of the workers.

When using the proposed kit in a dust device, it is in each case provided that a fluid stream to be analyzed is sent through a measuring path, the measuring path preferably beginning after the separating device in the flow direction of the fluid stream and leading through the particle sensor of the kit. The fluid stream comprises particles of which the properties are to be examined with the particle sensor. The proposed kit is constructed in such a way that the fluid stream first flows into the separating device, those particles which have a diameter of greater than 10 μm, i.e. are not respirable, being filtered out of the fluid stream by the separating device. Only the respirable particles with a diameter of less than 10 μm are allowed to pass through the separating device and can remain in the fluid stream. The fluid stream then enters a measuring region of the preferably optically operating particle sensor. The particles remaining in the fluid stream are examined there. The fluid stream then leaves the proposed kit and continues its way through the dust device.

It may also be preferred in the context of the invention that a personal dust detection device interacts with an air cleaner and/or a vacuuming device. The data collection or the fine dust quantity or exposure may take place for example in the personal dust detection device, while the data determined are used to control the operation of the air cleaner or the vacuuming device. In this sense, the personal dust detection device represents an external dust detection module, the measurement results of which are used to control dust devices, such as air cleaners and/or vacuuming device. In this preferred embodiment of the invention, the proposed kit may be part of the personal dust detection device and/or the further dust device, such as an air cleaner or vacuuming device. In this embodiment of the invention, it is preferred that there is a communication link between the personal dust detection device and the air cleaner or the vacuuming device. This may for example be based on WLAN or Bluetooth. It may also be preferred in the context of the invention that the proposed kit, for example as an internal dust detection module, is integrated in the air cleaner or the vacuuming device. The fluid stream to be examined may for example then be branched off from a larger fluid stream flowing through the dust device in the sense of a bypass.

In a further aspect, the invention relates to a dust device which comprises a proposed kit. The dust device is in particular an air cleaner, a vacuuming device or a (personal) dust detection device. The proposed dust device comprises in particular a particle sensor and a separating device, the particle sensor being set up to analyze particles in a fluid stream. The separating device is arranged upstream of the particle sensor within the kit and is also set up to leave only respirable particles in the fluid stream. This means that the separating device allows in particular those particles which have a particle diameter of 0 to 10 μm to pass through. Such particles with a particle diameter of 0 to 10 μm are referred to in particular as “fine dust”. In the proposed dust device, advantageously only such fine dust particles reach the particle sensor. This means that also only the respirable particles are analyzed by the particle sensor and only those measurement data which are based on such fine dust measurements are used for example for controlling the dust device.

In yet another aspect, the invention relates to a method for controlling a proposed dust device, the dust device having a proposed kit with a separating device and a particle sensor. The method is characterized by the following steps:
a) providing a proposed dust device, the dust device comprising a proposed kit,
b) determining measurement data relating to the particles in the fluid stream, the measurement data being determined with the particle sensor of the proposed kit,
c) controlling the dust device in dependence on the measurement data determined in step b).

It is particularly preferred in the context of the invention that the dust device has a proposed kit with a separating device arranged upstream of a particle sensor. In other words, the proposed control method is also based on the particularly clever arrangement of the separating device and the particle sensor within the proposed kit. By virtue of this advantageous arrangement, only the particles that are really relevant to health due to their size are examined by the particle sensor, while the remaining particles, which would reduce the accuracy of the measurement, are previously removed from the fluid stream by the separating device. As a result, particularly accurate measurement data can be provided for the control of the dust device and the dust device can for example be operated in a particularly energy-saving, quiet or filter-friendly manner.

It is preferred in the context of the invention that the kit takes the form of an external or internal dust detection module. In other words, the kit may represent an external dust detection module that is in connection with a dust device in terms of information technology via a communication link, so that for example measurement data or control commands can be exchanged. In this embodiment of the invention, the kit, an external dust detection module, can be set up for example in a room of which the air quality is to be monitored. This may be for example a room in a building to be renovated in which work is carried out with a handheld power tool, with dust being generated during the work. The external dust detection module, which in particular has a particle sensor and a separating device arranged upstream of the particle sensor, can then examine the particles in a fluid stream and transmit the determined measurement data to a dust device. There, the measurement data can be used to make settings on the dust device, and consequently to control the dust device. For this purpose, the dust device may comprise a control unit. It is preferred in the context of the invention that there is a communication link between the kit and the dust device. This preferably applies when the kit takes the form of an external dust detection module and in particular is not integrated in the dust device.

In an alternative embodiment of the invention, the kit may represent an integrated dust detection module within the dust device. In this case, a small fluid stream can be branched off from a larger fluid stream flowing through the device and analyzed.

The terms, definitions and technical advantages introduced for the kit preferably apply analogously to its use, the dust device and the proposed control method.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows a schematic representation of a preferred embodiment of the kit

FIG. 2 shows a schematic representation of a preferred embodiment of the dust device which interacts with a preferred embodiment of the kit as an external dust detection module

FIG. 3 shows a schematic representation of a preferred embodiment of the dust device which interacts with a preferred embodiment of the kit as an integrated dust detection module

### DETAILED DESCRIPTION OF THE DRAWINGS

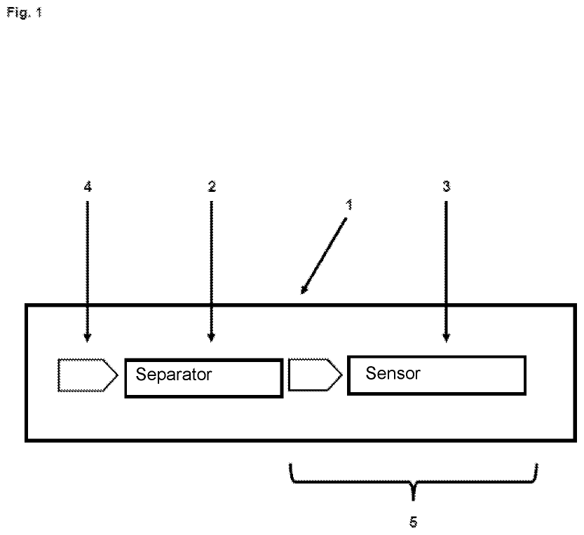

FIG. 1 shows a preferred embodiment of the proposed kit (1). In particular, FIG. 1 shows the components of the kit (1), i.e. the separating device (2) and the particle sensor (3). The particle sensor (3) is set up to analyze particles in a fluid stream (4). For this purpose, the fluid stream (4) is sent through the separating device (2) and the particle sensor (3). According to the invention, it is provided that the separating device (2) is set up to filter those particles which have a diameter of greater than 10 μm out of the fluid stream (4). This filtering or size selection may take place for example by means of a cyclone, a centrifugal separator or a deflection chamber. The particles with a diameter of greater than 10 μm are removed from the fluid stream (4) by the separating device (2). The fluid stream (4) and the particles remaining in the fluid stream (4) downstream of the separating device (2) in the direction of flow are passed on in the direction of the particle sensor (3). There they pass the measuring path (5), which preferably includes a measuring region of the particle sensor (3). Preferably only those particles which have a diameter of less than 10 μm or the diameter of which is in a range from 0 to 10 μm reach the measuring path (5). These particles are particularly health-relevant particles because they pass the walls of the alveoli and can thus get into the interior of the human organism. They are preferably referred to in the context of the invention as “respirable” or as “fine dust”. It is preferred in the context of the invention that the particles in the fluid stream (4) or in the measuring path (5) are examined by the particle sensor (3) using optical analysis methods. These may be for example methods based on the scattering of laser light.

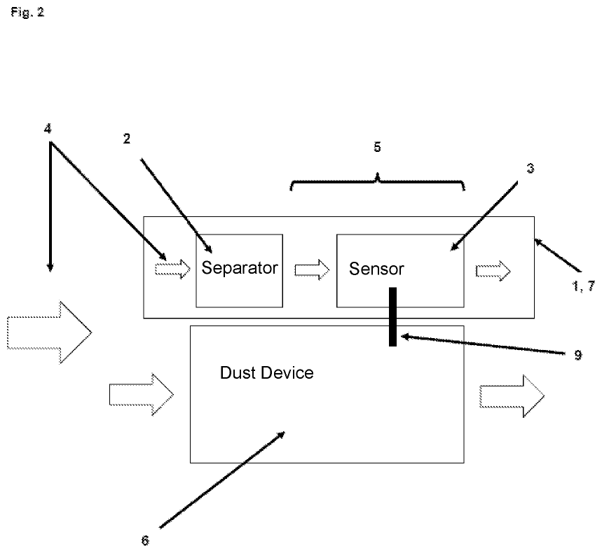

FIG. 2 shows a schematic representation of a preferred embodiment of the kit (1), the kit (1), as an external dust detection module (7), interacting with a dust device (6). The dust device (6) may be an air cleaner, a vacuuming device or a (personal) dust detection device, without being restricted thereto. It is preferred in the context of the invention that the kit (1) with its components, the separating device (2) and the particle sensor (3), takes the form of a self-contained unit outside the dust device (6). There may preferably be a communication link (9) between the dust device (6) and the kit (1). In other words, the kit (1) and the dust device (6) can communicate with each other using a communication link (9). This communication may for example consist in the exchange of data, measurement results and/or control commands, without being restricted thereto. The communication connection (9) preferably exists in particular between the particle sensor (3) of the kit (1) and the dust device (6). For the purpose of establishing the communication link (9), the kit (1) may comprise a communication device, such as a transmitter (not shown). To obtain the data from the kit (1), the dust device (6) may comprise a communication device (not shown) designed as a receiver. The communication link (9) between the kit (1) and the dust device (6) is preferably bidirectional, so that for example the kit (1) or its particle sensor (3) may also be set up for receiving data and the dust device (6) may be set up for sending data. The dust device (6) may also comprise a control unit (not shown) in which for example the data obtained from the particle sensor (3) of the kit (1) can be evaluated and converted into control commands for the dust device (6). It is particularly preferred in the context of the invention that the dust device (6) can be controlled in dependence on the measurement results that are determined with the kit (1) or its particle sensor (3).

The kit (1) can preferably be used to examine the air or its load with particles of different sizes in the vicinity of the dust device (6). The dust device (6) is preferably a device through which a fluid stream (4) flows. This fluid stream (4) contains particles of which the properties are to be examined with the kit (1) or the particle sensor (3) of the kit (1). For this purpose, a bypass fluid stream (4), which is sent through the kit (1) instead of through the dust device (6), may be formed for example. The bypass fluid stream (4) or the particles contained therein preferably have essentially the same properties as the fluid stream (4) that flows through the dust device (6). This ensures that the measurement results that are determined with the kit (1) also apply to the dust device (6) and can be used to control it. Even when the proposed kit (1) is used as an external dust detection module (7), the separating device (2) is arranged upstream of the particle sensor (3) within the kit (1). As a result, the non-respirable particles can be filtered out of the fluid stream (4) with the separating device (2) before they reach the measuring path (5) or the particle sensor (3).

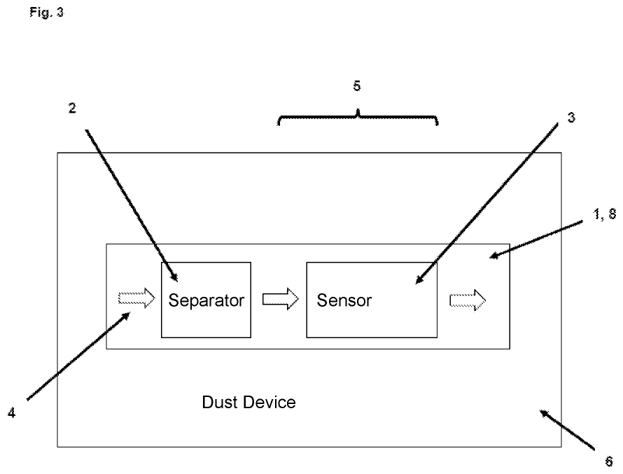

FIG. 3 shows a schematic representation of a preferred embodiment of the dust device (6), the dust device (6) interacting with a preferred embodiment of the kit (1) as an integrated dust detection module (8). In the preferred embodiment of the invention shown in FIG. 3, the proposed kit (1) takes the form of an internal dust detection module (8) and may for example be integrated in the dust device (6). In other words, the proposed kit (1) may be designed as an internal dust detection module (8). It may for example represent a self-contained unit that is present for example in the interior of the dust device (6). In an alternative embodiment of the invention, it may be preferred that the internal dust detection module (8) is arranged on an outer side or outer wall of the dust device (6). Preferably, the kit (1) designed as an internal dust detection module (8) can be easily removed from the dust device (6) and exchanged. The internal dust detection module (8) may for example be connected to the dust device (6) by means of data or power supply lines (not shown). The internal dust detection module (8) may preferably be supplied with energy via the energy supply lines, while communication in the sense of an exchange of data, measurement results and/or control commands may take place via the data lines. It is particularly preferred in the context of the invention that the dust device (6) can be controlled with measurement results that are determined by the kit (1) or the particle sensor (3) of the kit (1). For this purpose, the measurement results of the internal dust detection module (8) may be transmitted to the dust device (6) or a control unit (not shown) of the dust device (6). In a first preferred embodiment of the invention, it may be preferred that the measurement results are evaluated in the kit (1) itself and control commands for the dust device (6) are derived from the measurement results, in this embodiment of the invention in particular the control commands being transmitted to the dust device (6). In an alternative embodiment of the invention, the evaluation of the measurement results may take place in the dust device (6) or in the control unit of the dust device (6). In this case, in particular the raw or essentially raw measurement data or measurement results are transmitted from the internal dust detection module (8) to the dust device (6).

### LIST OF REFERENCE SIGNS

1 Kit

2 Separating device

3 Particle sensor

4 Fluid stream

5 Measuring path

6 Dust device

7 External dust detection module

8 Internal or integrated dust detection module

9 Communication link

1-11. (canceled)

12. A kit comprising:
a separator and a particle sensor, the particle sensor set up to analyze particles in a fluid stream, the separator being arranged upstream of the particle sensor and set up to leave only respirable particles in the fluid stream, so that only the respirable particles reach the particle sensor and are analyzed by the particle sensor.

13. The kit as recited in claim 12 wherein the separator is a centrifugal separator, deflection chamber or as a cyclone.

14. The kit as recited in claim 12 wherein the separator is a selectively operating separator.

15. The kit as recited in claim 12 wherein the particle sensor is an optical particle sensor.

16. A method for using the kit as recited in claim 12 comprising operating the kit in a dust device.

17. The method as recited in claim 16 wherein the dust device is controlled in dependence on measurement data collected with the kit.

18. The method as recited in claim 16 wherein the dust device is an air cleaner, a vacuuming device or a dust detection device.

19. A dust device comprising the kit as recited in claim 12.

20. A method for controlling the dust device recited in claim 19, the method comprising:
determining measurement data relating to the particles in the fluid stream, the measurement data being determined with the particle sensor; and
controlling the dust device in dependence on the measurement data.

21. The method as recited in claim 20 wherein the kit is an external dust detection module external to the dust device.

22. The method as recited in claim 20 wherein the kit is an internal dust detection module in the dust device.

23. The method as recited in claim 20 further comprising a communication link between the kit and the dust device.
